(19) United States
(12) Patent Application Publication
(10) Pub. No.: US 2025/0050416 A1
(43) Pub. Date: Feb. 13, 2025

(54) BRIDGING INTERNAL CHANNELS IN 3D-PRINTED OBJECTS

(71) Applicant: Additive Technologies, LLC d/b/a ADDiTEC, Palm City, FL (US)

(72) Inventors: PriyaankaDevi Guggilapu, Durham, NC (US); David A. Mantell, Rochester, NY (US); Dinesh Krishna Kumar Jayabal, Cary, NC (US); Collin Alexander Ladd, Charlotte, NC (US)

(73) Assignee: Additive Technologies, LLC d/b/a ADDiTEC, Palm City, FL (US)

(21) Appl. No.: 18/233,134

(22) Filed: Aug. 11, 2023

(51) Int. Cl. B22F 10/22; B22F 10/85; B22F 12/30; B33Y 10/00; B33Y 30/00; B33Y 50/02

(52) U.S. Cl. CPC B22F 10/22; B22F 10/85; B22F 12/30; B33Y 10/00; B33Y 30/00; B33Y 50/02

(57) ABSTRACT

A method of printing an internal bridge in a three-dimensional object includes depositing a plurality of drops of a printing material in a first direction to form a supported stepout onto an edge of a bridging layer, depositing a plurality of drops of the printing material to form an anchor layer adjacent to and in contact with a supported stepout, and depositing a plurality of drops of the printing material to form an unsupported stepout adjacent to an in contact with the supported stepout. A printing system for three-dimensional objects is also described, which is configured to perform the method of printing an internal bridge in a three-dimensional object.

### TECHNICAL FIELD

The present teachings relate generally to three-dimensional (3D) printing and, more particularly, to systems and methods for printing a bridge over an internal channel in a 3D part using a 3D printer.

### BACKGROUND

Three-dimensional (3D) printing jets a liquid build material through an ejector. A plurality of drops of the liquid build material are ejected from a nozzle of the ejector. The drops fall onto a build plate where they cool and solidify to form a 3D part. Oftentimes, it is desirable to print a channel in the 3D part. Conventionally, the maximum bridging distance (and thus the maximum width of the channel) without using supports is about 1.75 mm. More particularly, two supports may be spaced 1.75 mm apart, and seven bridge lines (also referred to as overhang segments or unsupported step-outs) of 0.25 mm each may be printed in the XY plane to bridge the distance therebetween. This corresponds to one or more of the bridge lines being printed from the first pillar toward the second pillar (e.g., 0.875 mm), and one or more of the bridge lines being printed from the second pillar toward the first pillar (e.g., 0.875 mm), and they may meet in the middle to form the 1.75 mm bridge. However, it would be desirable to be able to increase the maximum bridging distance in 3D-printed parts.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method of printing an internal bridge in a three-dimensional object is disclosed. The method includes depositing a plurality of drops of a printing material in a first direction to form a supported stepout onto an edge of a bridging layer, depositing a plurality of drops of the printing material to form an anchor layer adjacent to and in contact with a supported stepout, depositing a plurality of drops of the printing material to form an unsupported stepout adjacent to an in contact with the supported stepout, and where the anchor layer is formed with a first drop spacing the unsupported stepout is formed with a second drop spacing, the first drop spacing is from about 1.75 times to about 2.50 times that of the second drop spacing, and the internal bridge formed by the unsupported stepout and the anchor layer are disposed at an angle relative to the edge of the bridging layer of 0 degrees to about 30 degrees. Implementations of the method of printing an internal bridge in a three-dimensional object can include where the first drop spacing is 0.7 mm, or the second drop spacing is 0.32 mm. Each drop of the plurality of drops used to form the unsupported stepout can be deposited in the first direction. Each drop of the plurality of drops used to form the anchor layer can be deposited in a second direction opposite to the first direction. The unsupported stepout is formed at a line spacing of 0.25*n mm from a supported stepout, where n is an n'th unsupported stepout. The anchor layer is formed at a line spacing of n*0.25+0.125 mm from the supported stepout, where n is an n'th anchor stepout. The method of printing an internal bridge in a three-dimensional object may include (a) depositing a third plurality of drops of the printing material to form an anchor layer adjacent to and in contact with a supported stepout at a third drop spacing. (b) depositing a plurality of drops of the printing material to form an unsupported stepout adjacent to an in contact with the anchor layer at a second drop spacing, and (c) repeating steps (b) and (c) until a required number of unsupported stepouts are deposited. The method of printing an internal bridge in a three-dimensional object may include increasing a temperature of an area surrounding the three-dimensional object. The method of printing an internal bridge in a three-dimensional object may include heating a portion of the internal bridge. In examples, no print material is deposited between the unsupported stepout or the anchor layer and a substrate. No support material is between the unsupported stepout or the anchor layer and a substrate. The anchor layer is formed at a line spacing of n*0.25+0.125 mm from the supported stepout, where n is an n'th anchor stepout.

A printing system for three-dimensional objects is disclosed. The printing system includes a reservoir configured to receive and melt a print material and an ejector having a nozzle that is fluidly connected to the reservoir to receive melted print material from the reservoir. The system also includes a platform positioned opposite the ejector. The system also includes at least one actuator operatively connected to at least one of the platform and the ejector, the at least one actuator being configured to move the at least one of the platform and the ejector relative to one another. The system also includes a controller operatively connected to the reservoir, the ejector, and the at least one actuator, the controller being configured to: deposit a plurality of drops of a printing material in a first direction to form a supported stepout onto an edge of a bridging layer, deposit a plurality of drops of the printing material to form an anchor layer adjacent to and in contact with the supported stepout. The system also includes deposit a plurality of drops of the printing material to form an unsupported stepout adjacent to an in contact with the supported stepout, and where the anchor layer is formed with a first drop spacing the unsupported stepout is formed with a second drop spacing, the first drop spacing is from about 1.75 times to about 2.50 times that of the second drop spacing, and an internal bridge formed by the unsupported stepout and the anchor layer are disposed at an angle relative to the edge of the bridging layer of 0 degrees to about 30 degrees. Implementations of the printing system for three-dimensional objects includes where the first drop spacing is 0.7 mm, and the second drop spacing is 0.32 mm. Each drop of the plurality of drops used to form the unsupported stepout is deposited in a first direction. Each drop of the plurality of drops used to form the anchor layer is deposited in a second direction opposite to the first direction. The unsupported stepout is formed at a line spacing of 0.25*n mm from a supported stepout, where n is an n'th unsupported stepout.

A method of printing an internal bridge in a three-dimensional object is disclosed. The method of printing an internal bridge includes calculating a number of unsupported stepout layers, n, in the internal bridge based on a lateral dimension of an overhang of the internal bridge divided by a line width, depositing an anchor layer in a first direction at a first drop spacing, and depositing an unsupported stepout in a second direction at a second drop spacing, where: the second direction is opposite of the first direction. Implementations of the method of printing an internal bridge in a three-dimensional object where the line width is 0.25 mm, the first drop spacing is 0.7 mm, and the second drop spacing is 0.32 mm. The method of printing an internal bridge in a three-dimensional object may include forming the unsupported stepout at a line spacing of 0.25*n mm from a supported stepout, where n is an n'th unsupported stepout, and forming the anchor layer at a line spacing of n*0.25+0.125 mm from the supported stepout, where n is an n'th anchor stepout.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid metal ejector jet of a 3D printer (e.g., a MHD printer and/or multi-jet printer), in accordance with the present disclosure.

FIGS. 2A and 2B depict a perspective view of a 3D part including a first channel opening and a second channel opening, and a cross-sectional perspective view of the 3D part showing a channel extending from the first channel opening to the second channel opening, respectively, in accordance with the present disclosure.

FIGS. 3A and 3B depict a schematic overhead view of a bridge that may be printed over the channel, and another schematic overhead view of a bridge that may be printed over the channel having dimensional indicators, respectively, according to an embodiment. FIG. 3C depicts the bridge from FIG. 3B identifying anchors, supported step-outs, and unsupported step-outs, in accordance with the present disclosure.

FIGS. 4A and 4B depict a zero degree (0°) horizontal overhang that is 10 mm wide and printed with experimental values and a cross-section of a step-out distance, respectively, in accordance with the present disclosure.

FIG. 5 illustrates a flowchart of a method for bridging a channel in the 3D part using the 3D printer, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

For the purposes of the present disclosure, the term print path can be defined as a path, or course, that a drop-on-demand printer follows according to its executed programmed instructions for completion of an object build. Line spacing can be defined as a distance interval between a printed line and a neighboring or adjacent printed line as a drop-on-demand printer follows programmed instructions for completion of an object build. Alternatively, line spacing can be considered to be a distance between one print path and an adjacent, sometimes parallel print path. Drop spacing can be defined as an interval between drops ejected from a drop-on-demand printing system. The interval between or drop spacing can be expressed in dimensions of time, for example, milliseconds, or distance, such as millimeters. In this context, drops are spaced apart along a single print path or line.

The term bridging layer refers to the last layer of a 3D object or part build before a stepout is formed. A stepout, or step-out is defined as a layer or plurality of drops that are deposited or printed by an ejector that divert in a horizontal plane from an edge or bridging layer of a 3D part or object. A supported stepout is defined as a series of drops, or droplets in full contact with and on top of the bridging layer or other support structure in a 3D object. An unsupported stepout is defined as a series of drops within an overhang that has a similar drop spacing as the bridging layer and supported stepout, wherein no print material is deposited between the unsupported stepout and a substrate. An anchor layer is a series of drops within an overhang that has a larger drop spacing as compared to the bridging layer, supported stepout, or unsupported stepout, wherein no print material is deposited between the anchor layer and a substrate. An overhang is an unsupported structure formed during the build, fabrication, or printing of a three-dimensional object or part. An unsupported structure has no print material or support structure between that overhanging portion of the 3D part and the platform or substrate onto which the 3D part is built.

In a liquid drop-on-demand (DOD) jetting printing system, being able to produce unsupported overhangs is critical to expanding the range of designs that can be printed, in particular for internal cavities where a support pillar cannot be accessed to be removed after a three-dimensional (3D) part is completed. One such application includes bridging an internal channel within a 3D object build. The present disclosure provides a system and method to create 0 degree (horizontal) overhangs forming an internal bridge including depositing a plurality of drops of a printing material in a first direction to form a supported stepout onto an edge of a bridging layer, depositing a plurality of drops of the printing material to form an unsupported stepout adjacent to an in contact with the supported stepout, and depositing a plurality of drops of the printing material to form an anchor layer adjacent to and in contact with the unsupported stepout. In examples of this method, an anchor layer is formed with a first drop spacing, an unsupported stepout is formed with a second drop spacing, where the first drop spacing is from about 1.75 times to about 2.50 times that of the second drop spacing and the internal bridge formed by the unsupported stepout and the anchor layer are disposed at an angle relative to the edge of the bridging layer of 0 degrees to about 30 degrees.

For the purposes of this disclosure, an overhang can be defined as an unsupported feature of a 3D printed part that is not held up or supported by an underlying support structure or other printed element. A layer-by-laver printing approach involving a liquid or molten print material can produce one or more undersides of a slope in a part, where each subsequent layer must protrude slightly beyond a preceding layer. As the molten printed material is still in its flowable liquid state prior to solidification, gravity and other factors, such as the angle and slope of the overhang, can result in drooping or sagging, curling, or the prohibition of printing a desired shape altogether. An extended overhang refers to an overhang extending in an outward facing or lateral direction relative to a previously formed portion of a three-dimensional part with only one contiguous area of contact between an initial portion of a three-dimensional part and the overhang. A central overhang refers to an overhang extending in an inward facing or lateral direction relative to a previously formed portion of a three-dimensional part with more than one, i.e. at least two, contiguous area of contact between an initial portion of a three-dimensional part and the central overhang. By way of example, a central overhang can also be referred to as a bridge or bridging layer within an entire structure of a three-dimensional part. For the purposes of this disclosure, the term “stepout” can be used interchangeably with overhang, as the ejected drops forming the unsupported overhang structure can be considered to “step out” at a 0 degree angle from a horizontal plane associated with a three-dimensional part or object in progress of being printed or created.

Examples of the present disclosure provide a printing approach that enables the printing of complex features such as re-entrant geometries, hollow features, overhangs, and fine internal bridging features which traditional tools cannot machine due to space constraints or reachability and the like. These features may be printed using methods and systems of the present disclosure by printing structures and features which are divided among multiple layers and wherein fairly simple 2D layers can be printed one above the other until the entire object is completed.

Certain liquid printing processes can provide three-dimensional parts having extreme overhangs as described herein are only possible by bridging over support structures. Currently, support structure layers are made of finely spaced extended, solid supports constructed of a print material including aluminum or another applicable print material. Once the part has completed printing, these support structures must be removed, which can often leave a rough overhanging side due to molten metal or molten print material sinking between the fine gaps of the support structures prior to solidification and some remnant support structures can still be left attached to the part after support removal. This involves one or more secondary operations post-printing to provide a better surface finish. The printing of unsupported overhangs can provide printing processes having improved efficiency, reduced post-processing, and the like. When the design parameters of an object built in this manner dictate an internal channel, it can be particularly prohibitive to remove a support structure from an internal channel or structure.

In previous printing methods, the formation of support structures in 3D metal objects with drop ejecting 3D object printer is explored. In these studies, the maximum bridging distance originally achievable without any supports was 7*0.25 mm=1.75 mm (support pillars separated by 7 intervals each of 0.25 mm), which corresponds to printing 0.875 mm long overhanging segments printed from the opposite ends made to meet in the middle (1.75/2=0.875 mm). As each of the newly printed bridging line steps out of the previous line in the XY plane, they are called “unsupported step outs.” In the present teachings, a new toolpath for printing the bridges without any supports beyond 1.75 mm for a 475-micron nozzle size is described.

Internal channels are common features found in various 3D object design applications, such as manifolds and heat exchangers. These features are basically used to allow fluids to pass through the structure of the parts for effective performance of the part. These features are difficult to produce using traditional manufacturing methods. The present disclosure provides experimentally determined method for providing printed parts with internal bridging over channels or other structures.

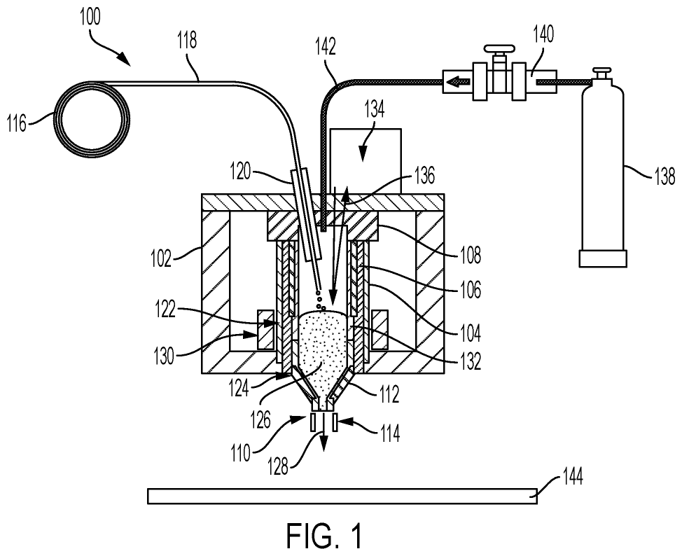

FIG. 1 depicts a schematic cross-sectional view of a single liquid metal ejector jet of a 3D printer (e.g., a MHD printer and/or multi-jet printer), in accordance with the present disclosure. FIG. 1 shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block. The ejector 104 may define an inner volume 132 (also referred to as an internal cavity or an inner cavity). A printing material 126 may be introduced into the inner volume 132 of the ejector 104. This inner volume 132 may be considered a reservoir configured to receive and melt a print material within the inner volume 132 of the ejector 104. The printing material 126 may be or include a metal, a polymer, or the like. It should be noted that alternate jetting technology aside from MHD as described herein may be necessary depending on the nature and properties of the print material used in examples of the present disclosure. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. This electrical current can be provided as a pulse, which is delivered at a specific frequency, wherein the frequency determines a rate at which a pulse is delivered to the coils 106, and therefore how often a drop may be ejected from the ejector 104. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, known as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate 144, or platform that is positioned proximate to (e.g., below) the nozzle 110. The ejected drops 128 may land on the substrate 144 and solidify to produce a 3D object. The 3D printer 100 may also include a substrate control motor that is configured to move the substrate 144 while the drops 128 are being jetted through the nozzle 110, or during pauses between when the drops 128 are being jetted through the nozzle 110, to cause the 3D object to have the desired shape and size. The substrate control motor may be configured to move the substrate 144 in one dimension (e.g., along an X axis), in two dimensions (e.g., along the X axis and a Y axis), or in three dimensions (e.g., along the X axis, the Y axis, and a Z axis). In another example, the ejector 104 and/or the nozzle 110 may be also or instead be configured to move in one, two, or three dimensions. In other words, the substrate 144 may be moved under a stationary nozzle 110, or the nozzle 110 may be moved above a stationary substrate 144. In yet another example, there may be relative rotation between the nozzle 110 and the substrate 144 around one or two additional axes, such that there is four or five axis position control. In certain examples, both the nozzle 110 and the substrate 144 may move. For example, the substrate 144 may move in X and Y directions, while the nozzle 110 moves up and/or down in a Y direction. For the purposes of this disclosure, a print bed may also refer to the substrate.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another example, the gas may be or include nitrogen. The gas may include less than about 10% oxygen, less than about 5% oxygen, or less than about 1% oxygen. In at least one example, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate 144 to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one example, the enclosure 102 may be hermetically sealed. In another example, the enclosure 102 may not be hermetically sealed. In one example, the ejector 104, the heating elements 112, the power source, the coils, the substrate 144, additional system elements, or a combination thereof may be positioned at least partially within the enclosure 102. In another example, the ejector 104, the heating elements 112, the power source, the coils, the substrate 144, additional system elements, or a combination thereof may be positioned at least partially outside of the enclosure 102. While the liquid ejector jet system 100 shown in FIG. 1 is representative of a typical liquid ejector jet system 100, locations and specific configurations and/or physical relationships of the various features may vary in alternate design examples.

Printing systems as described herein or printing systems having other print material feeds and/or ejection systems may alternatively include other printing materials such as plastics or other ductile materials that are non-metals. The print material can include a metal, a metallic alloy, or a combination thereof. A non-limiting example of a printing material can include aluminum. Exemplary examples of printing systems of the present disclosure can include an ejector for jetting a print material, including a structure defining an inner cavity, and a nozzle orifice in connection with the inner cavity and configured to eject one or more droplets of liquid print material, wherein the ejector is configured to form an overhang for a three-dimensional printed part.

In other known methods, printers such as those shown in FIG. 1 include a controller that is configured to receive instructions from a computing device or programmed set of coordinates to operate the ejector head to construct various elements of a 3D object. The reservoir or inner volume is configured to receive and melt a print material, while the ejector having a nozzle is fluidly connected to the reservoir to receive melted print material from the reservoir. As the platform is positioned opposite the ejector, at least one actuator operatively connected to at least one of the platform and the ejector is present, where the at least one actuator is configured to move the at least one of the platform and the ejector relative to one another. The controller is further operatively connected to the reservoir, the at least one ejector, and the at least one actuator, the controller being configured to perform various printing method instructions as described herein.

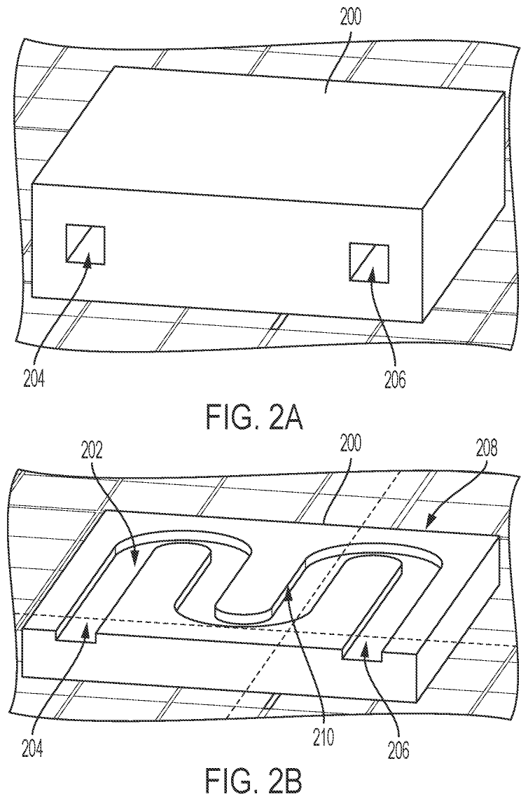

FIGS. 2A and 2B depict a perspective view of a 3D part including a first channel opening and a second channel opening, and a cross-sectional perspective view of the 3D part showing a channel extending from the first channel opening to the second channel opening, respectively, in accordance with the present disclosure. FIG. 2A depicts a perspective view of the 3D part 200, and FIG. 2A depicts a cross-sectional perspective view of the 3D part 200, according to an embodiment. The 3D part 200 may include an internal channel 202 that extends from a first channel opening 204 to a second channel opening 206. In an example, the 3D part 200 may be a manifold or heat exchanger, and the channel 202 may be used to allow fluids to pass through the 3D part 200 for effective performance. In the operative steps of a 3D printing system, as described herein, the tool pathing for unsupported step outs to print an internal bridge may be employed. The 3D printer 100 may print an internal bridge 210 over at least a portion of the channel 202. As described in greater detail below, the bridge 210 may include plurality of unsupported step-outs. The distance between the unsupported step-outs may be from about 0.10 mm to about 0.40 mm or about 0.20 mm to about 0.30 mm (e.g., 0.25 mm), or from 0.19 mm to about 0.25 mm. To print the bridge 210 beyond (i.e., wider than) 1.75 mm, a plurality of anchor drops may be printed. The anchor drops may be placed sparsely, barely touching the previously-printed unsupported step out so the anchor drops can be used as a support for the next unsupported step-out line. The anchor drops may form an anchor line or anchor layer. The anchor layer may have a drop spacing from about 0.5 mm to about 1.0 mm or about 0.6 mm to about 0.8 mm (e.g., 0.7 mm). As used herein, drop spacing, refers to the spacing between drops in a (e.g., linear or curved) printing path such as the anchor line. The anchor drops may be placed from about 0.100 mm to about 0.150 mm (e.g., 0.125 mm) away from the previous unsupported step-out

The starting point of the anchor drop(s) for each anchor line may be printed randomly to avoid the deposition at the same point for every unsupported step-out. As used herein, printing randomly refers to beginning the deposition of a first anchor drop within an anchor layer at a randomly determined position along an anchor line or anchor layer. In this manner, the anchor drops may be started randomly at various positions along an anchor line, because there may be overbuilding only in the regions were the drops of the unsupported step-out lines overlap the sparsely spaced drops of the anchor lines. The drop spacing and/or line spacing values for unsupported step-outs, anchors are determined experimentally by printing a curved bridge and changing the values for every iteration. The anchor drops are deposited onto unsupported stepouts. Drop spacing in an anchor layer is larger than adjacent line path drop spacings. Alternating direction in depositing an anchor layer provides time for the drops to cool appropriately before returning to print additional drops or subsequent layers. Starting the anchor drops at random positions along a path or line disrupts the anchor drops from being deposited at a regular interval. If deposited in a regular interval, this can result in building too much material in a location, thus producing discernible patterns in a part build. The location of a first anchor drop in an anchor layer is randomly selected between maximum drop spacing and minimum drop spacing. This larger drop spacing between anchor drops allows for faster cooling or solidification of anchor drops after depositing due to sparser drop spacing. Neighboring lines, such as stepouts or standard fill printed layers are printed with smaller drop spacing, and therefore cool slower.

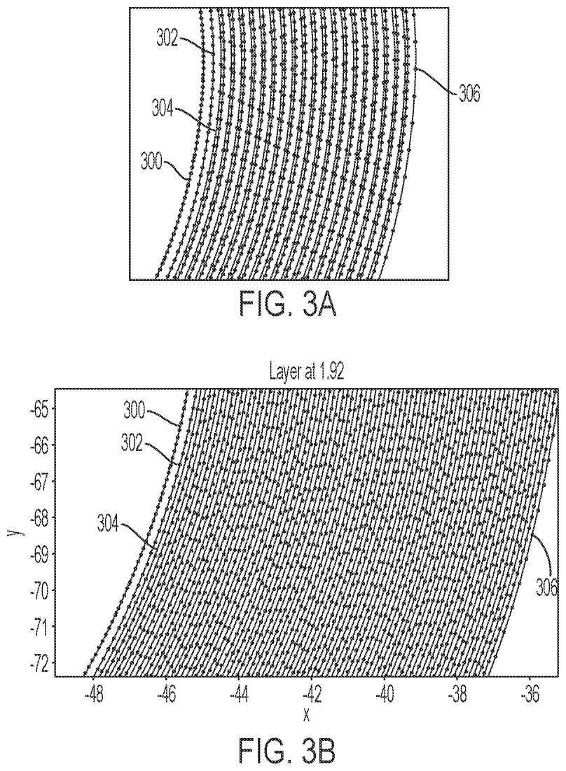

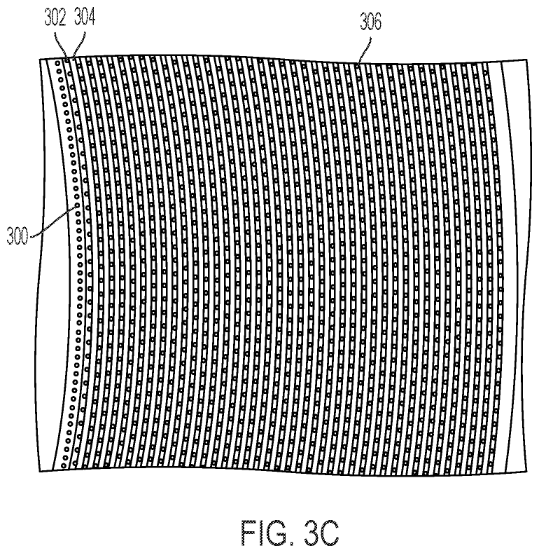

FIGS. 3A and 3B depict a schematic overhead view of a bridge that may be printed over the channel, and another schematic overhead view of a bridge that may be printed over the channel having dimensional indicators, respectively, according to an embodiment. FIG. 3C depicts the bridge from FIG. 3B identifying anchors, supported step-outs, and unsupported step-outs, in accordance with the present disclosure. As shown in FIG. 3A, there is an initial layer in the formation of the internal bridge comprised of a supported stepout 300, in which at least a portion of an underside of each individual drop 306 in the layer is supported below by another portion of the 3D object structure. Next is an unsupported stepout 302 layer followed by an anchor layer 304. For the remaining width of the internal bridge, the build alternates between an unsupported stepout 302 layer adjacent to and in contact with a preceding anchor layer 304, followed by an anchor layer 304 adjacent to and in contact with the preceding unsupported stepout 302 layer. This same arrangement is shown in FIG. 3B with approximate dimensions, shown in mm, overlaid with the drop and layer structure also shown in FIG. 3A. FIG. 3C shows a similar bridge structure in a schematic view, also highlighting the arrangement of the supported stepout 300, the unsupported stepout 302 layer and the anchor layer 304. FIG. 3C further shows the toolpath architecture for a (e.g., 10 mm) horizontal overhang on top of support at the bridging layer. In FIG. 3C, there are a total of 40 unsupported step-outs, each separated by a predetermined distance. The predetermined distance may be from about 0.10 mm to about 0.40 mm. For example, the predetermined distance may be 0.25 mm. In this example, 40 unsupported step-outs*0.25 mm=10 mm horizontal overhang). In other examples, the horizontal overhang for an internal channel can range from about 0.10 mm to about 25 mm.

### Example Toolpath for Printing a 0° One-Way Bridge

As used herein, and further shown in FIG. 3C, a bridging layer refers to a topmost or roof layer defining the uppermost portion of an internal channel in a 3D object or part. At the bridging layer, a supported step-out 300 with a 0.2 mm drop spacing may be printed on top on the pillars or at an edge of a solid portion of a 3D object. Then, an anchor 304 with a 0.7 mm drop spacing may be printed in a first (e.g., clockwise) direction at a distance of 0.125 mm from the unsupported step-out. Because the first unsupported step-out is 0.25 mm from the supported step-out, the first anchor may be printed at 0.25 mm+0.125 mm=0.375 mm from the supported step-out. Next, an unsupported step-out 302 with a 0.32 mm drop spacing may be printed in a second (e.g., counter-clockwise) direction at a distance of 0.25 mm from the supported step-out. Again, an anchor 304 with 0.7 mm drop spacing may be printed at 0.625 mm (2*0.25 mm+0.125 mm) in the clockwise direction. A new unsupported step-out 302 may be printed at 0.5 mm (2*0.25 mm) in the counter-clockwise direction. This may continue until the desired number of unsupported step-outs 302 are produced. The unsupported step-outs can start in two ways. The first way to start an unsupported step-out 302 is from a supported step-out 300. The second way to start an unsupported step-out 302 is from an inner perimeter.

### Printing an Internal Bridge, One-Way

Printing a 0° horizontal overhang at the bridging layer of a certain length in one-way may be determined as follows. The number of unsupported step-outs may be determined. The number of unsupported step outs (N)=length of horizontal overhang/0.25 mm. According to an example, this toolpath can be determined using logic for the code, as follows:

```
In an example, the supported step-out and/or the inner perimeter may be
at x direction = 1 -----> clockwise
for i= 1: floor(N)
    Print anchor at x+ i*0.25+1.25 along direction, drop spacing =
    0.7mm
    Print unsupported step-out at x+ i*0.25 along direction*−1, drop
    spacing 0.32mm direction = direction*−1
end
if N-floor(N)~=0
  Drop spacing for last unsupported step-out (ds_l) = 0.32+
  0.32*(ls_{d}−lsₐ)/ls_{d}
  ls_{d} is desired line spacing = 0.25
  lsₐ is actual line spacing = (N−floor(N)) *0.25
  Print anchor at x+ (floor(N) +1) *0.25+1.25 along direction, drop
  spacing = 0.7mm
    Print unsupported step-out at x+ (floor(N) +1) *0.25 along
    direction*−1, drop spacing= ds_l
End
```

### To Print an Internal Bridge, Two-Way

Printing a 0° horizontal overhang at the bridging layer of a certain length in two-way may be determined as follows. The number of unsupported step-outs may be determined. The number of unsupported step outs is also (N)=length of horizontal overhang/0.25 mm. According to an example, this toolpath can be determined as follows:

| | |
|---|---|
| 1. | Calculate the number of unsupported step outs |
| | Number of unsupported step outs (N)= length of horizontal |
| | overhang/ 0.25 |
| 2. | Suppose the supported step-out or the inner perimeter is at x1 and x2 |
| | on either side direction = 1 ----- > clockwise |
| | for i= 1: floor (N /2) |
| | Print anchor at x1+ i*0.25+1.25 along direction, drop spacing |
| | = 0.7mm |
| | Print unsupported step-out at x1+ i*0.25 along direction*−1, |
| | drop spacing 0.32mm |
| | Print anchor at x2+ i*0.25+1.25 along direction, drop spacing |
| | = 0.7mm |
| | Print unsupported step-out at x2+ i*0.25 along direction*−1, |
| | drop spacing 0.32mm |
| | direction = direction*−1 |
| | end |
| | if N/2−floor(N/2) ~=0 |
| | Remaining unsupported step outs (Nr) = (N/2−floor(N/2)) *2 |
| | If Nr <1 |
| | Drop spacing for last unsupported step-out (ds_l) = 0.32+ |
| | 0.32*(ls_{d}−lsₐ)/ls_{d} |
| | ls_{d} is desired line spacing = 0.25 |
| | lsₐ is actual line spacing = Nr *0.25 |
| | Print anchor at x1+ (floor(N/2) +1) *0.25+1.25 along direction, |
| | drop spacing = 0.7mm |
| | Print unsupported step-out at x1+ (floor(N/2) +1) *0.25 along |
| | direction*−1, drop spacing= ds_l |
| | else if Nr==1 |
| | Print anchor at x1+ (floor(N/2) +1) *0.25+1.25 along direction, |
| | drop spacing = 0.7mm |
| | Print unsupported step-out at x1+ (floor(N/2) +1) *0.25, |
| | direction*−1, drop spacing = 0.32mm |
| | else |
| | Print anchor at x1+ (floor(N/2) +1) *0.25+1.25 along direction, |
| | drop spacing = 0.7mm |
| | Print unsupported step-out at x1+ (floor(N/2) +1) *0.25, d |
| | irection*−1, drop spacing = 0.32mm |
| | Drop spacing for last unsupported step-out (ds_l) = 0.32+ 0 |
| | .32*(lsd−lsa)/lsd |
| | lsd is desired line spacing = 0.25 |
| | lsa is actual line spacing = (Nr−1) *0.25 |
| | Print anchor at x2+ (floor(N/2) +1) *0.25+1.25 along direction, |
| | drop spacing = 0.7mm |
| | Print unsupported step-out at x2+ (floor(N/2) +1) *0.25 along |
| | direction*−1, drop spacing= ds_l |
| | end |
| | end |

By following one of the above scenarios, it is possible to print the internal bridges or horizontal overhangs at 0° angle using this method without compromising the throughput, since the anchors and unsupported step-out are printed using a frequency of 300 Hz. When these features are printed, in some examples, they may not be exactly at 0°, but can vary as much as up to a 26.8° or up to 30° angle due to some inconsistent temperature as the toolpath is printing further away from the bulk of the part. By printing, in one example, a 10 mm horizontal overhang at 0°, a 11.21 mm horizontal overhang at 26.8° was achieved. This liftoff, or difference in realized angle compared to intended angle, is caused by uneven temperature throughout the printed object. As the unsupported step outs extend outwards, the deposited drops move away from the solid part region and their temperature is colder than the bulk of the part. Such a liftoff, or increasing angle relative to the horizontal, can be addressed by printing in an enclosure, increasing the bed temperature, increase in frequency or by targeted assisted heating, such as with a laser or other heating means, such as but not limited to radiation or convection heating methods. This method has been shown to be reliable in experimentation and can print large horizontal overhangs and bridges without any supports. While testing has been conducted up to 10 mm distances, it is understood that the methods described herein can be extended further, up to and including 25 mm. In examples, the line spacing for various layers, for example, an unsupported stepout is formed at a line spacing of 0.25*n mm from a supported stepout, where n is the n'th unsupported stepout. With respect to an anchor layer, the anchor layer can be formed at a line spacing of n*0.25+0.125 mm from the supported stepout, where n is the n'th anchor stepout. The variable, n, refers to a total number of unsupported stepouts comprising an internal bridge, where the “n'th” layer refers to the last layer in the internal bridge or structure.

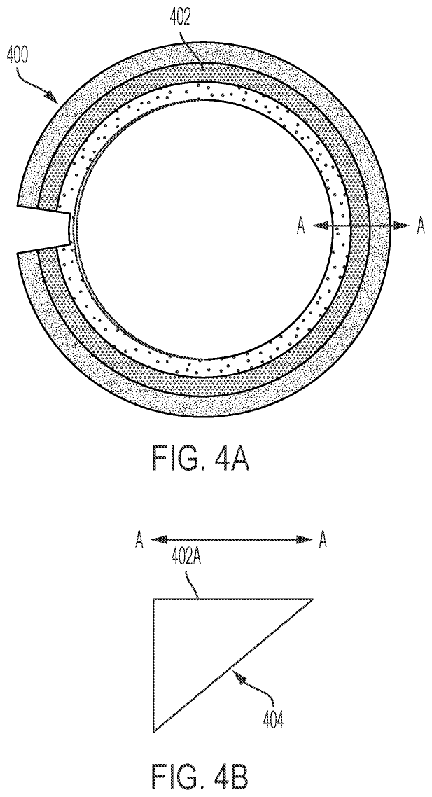

FIGS. 4A and 4B depict a zero degree (0°) horizontal overhang that is 10 mm wide and printed with experimental values and a cross-section of a step-out distance, respectively, in accordance with the present disclosure. A horizontal overhang structure 400 is shown with a top surface 402 comprising one or more unsupported stepout layers and anchor layers, as described previously herein. FIG. 4B is a cross-section of a total step-out distance 402A, as indicated by line A-A with an unsupported portion 404 of the part indicated as well. While a particular angle is shown in FIG. 4B, the angle shown is not necessarily representative of the underside of every part, as the angle may vary based on part design and specific printing conditions.

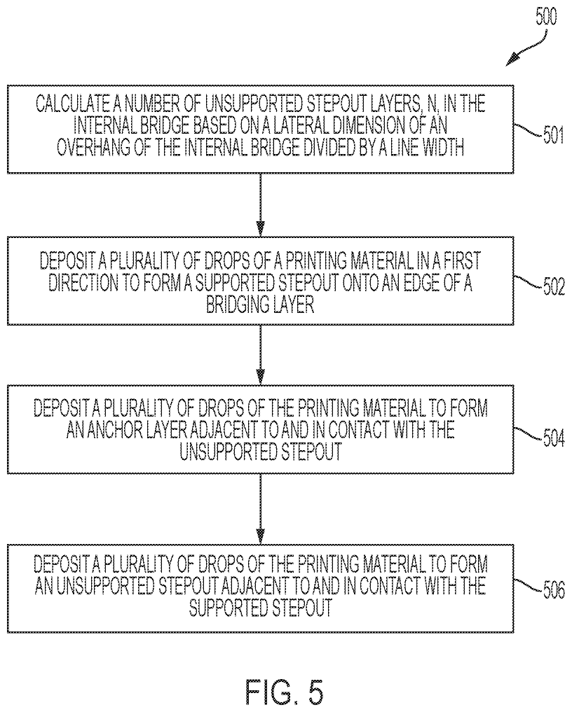

FIG. 5 illustrates a flowchart of a method for bridging a channel in the 3D part using the 3D printer, in accordance with the present disclosure. The method of printing an internal bridge in a three-dimensional object 500, includes the steps of depositing a plurality of drops of a printing material in a first direction to form a supported stepout onto an edge of a bridging layer 502, depositing a plurality of drops of the printing material to form an anchor layer adjacent to and in contact with the unsupported stepout 504, and depositing a plurality of drops of the printing material to form an unsupported stepout adjacent to an in contact with the supported stepout 506. In this method 500 the anchor layer is formed with a first drop spacing, the unsupported stepout is formed with a second drop spacing, the first drop spacing is from about 1.75 times to about 2.50 times that of the second drop spacing, and the internal bridge formed by the unsupported stepout and the anchor layer are disposed at an angle relative to the edge of the bridging layer of 0 degrees to about 30 degrees. The method 500 can include where the first drop spacing is 0.7 mm, the second drop spacing is 0.32 mm. In examples, the first drop spacing can be from about 0.45 mm to about 0.8 mm, from about 0.5 mm to about 0.7 mm, or from about 0.5 mm to about 0.6 mm. Also in certain examples, the second drop spacing can be from about 0.26 mm to about 0.32 mm, or from about 0.28 mm to about 0.30 mm.

In certain examples, the method 500 can include where each drop of the plurality of drops used to form the unsupported stepout is deposited in the first direction, and each drop of the plurality of drops used to form the anchor layer is deposited in a second direction opposite to the first direction. The method 500 further includes where the unsupported stepout is formed at a line spacing of 0.25*n mm from a supported stepout, where n is an n'th unsupported stepout, or the anchor layer is formed at a line spacing of n*0.25+0.125 mm from the supported stepout, where n is an n'th anchor stepout. The method of printing an internal bridge in a three-dimensional object 500 can further include the steps of (a) depositing a third plurality of drops of the printing material to form an anchor layer adjacent to and in contact with the unsupported stepout at a third drop spacing: (b) depositing a plurality of drops of the printing material to form an unsupported stepout adjacent to an in contact with the anchor layer at a second drop spacing; and (c) repeating steps (b) and (c) until a required number of unsupported stepouts are deposited. In some examples, the temperature of an area surrounding the three-dimensional object can be increased, by heating a portion of the internal bridge, or by other means known to a person skilled in the art. For example, the platform or substrate of a printing system can be heated, or an external heating method, such as laser or other radiative heat processing can be used. In employing the method 500, no print material is deposited between the unsupported stepout or the anchor layer and a substrate, and no support material is between the unsupported stepout or the anchor layer and a substrate.

In other examples of a method of printing an internal bridge in a three-dimensional object the steps of calculating a number of unsupported stepout layers, n, in the internal bridge based on a lateral dimension of an overhang of the internal bridge divided by a line width 501 can be completed prior to any physical operation of the printing system. These operative steps can include depositing an anchor layer in a first direction at a first drop spacing, and depositing an unsupported stepout in a second direction at a second drop spacing. In such an example, the second direction is opposite of the first direction. This method of printing an internal bridge in a three-dimensional object can include a line width of 0.25 mm, wherein the first drop spacing is 0.7 mm and the second drop spacing is 0.32 mm. The method of printing an internal bridge in a three-dimensional object can further include forming the unsupported stepout at a line spacing of 0.25*n mm from a supported stepout, where n is the n'th unsupported stepout, and forming the anchor layer at a line spacing of n*0.25+0.125 mm from the supported stepout, where n is the n'th anchor stepout.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method of printing an internal bridge in a three-dimensional object, comprising:
depositing a plurality of drops of a printing material in a first direction to form a supported stepout onto an edge of a bridging layer;
depositing a plurality of drops of the printing material to form an anchor layer adjacent to and in contact with a supported stepout; and
depositing a plurality of drops of the printing material to form an unsupported stepout adjacent to an in contact with the supported stepout; and wherein
the anchor layer is formed with a first drop spacing
the unsupported stepout is formed with a second drop spacing;
the first drop spacing is from about 1.75 times to about 2.50 times that of the second drop spacing; and
the internal bridge formed by the unsupported stepout and the anchor layer are disposed at an angle relative to the edge of the bridging layer of 0 degrees to about 30 degrees.

2. The method of printing an internal bridge in a three-dimensional object of claim 1, wherein the first drop spacing is 0.7 mm.

3. The method of printing an internal bridge in a three-dimensional object of claim 1, wherein the second drop spacing is 0.32 mm.

4. The method of printing an internal bridge in a three-dimensional object of claim 1, wherein each drop of the plurality of drops used to form the unsupported stepout is deposited in the first direction.

5. The method of printing an internal bridge in a three-dimensional object of claim 1, wherein each drop of the plurality of drops used to form the anchor layer is deposited in a second direction opposite to the first direction.

6. The method of printing an internal bridge in a three-dimensional object of claim 1, wherein the unsupported stepout is formed at a line spacing of 0.25*n mm from a supported stepout, where n is an n'th unsupported stepout.

7. The method of printing an internal bridge in a three-dimensional object of claim 1, wherein the anchor layer is formed at a line spacing of n*0.25+0.125 mm from the supported stepout, where n is an n'th anchor stepout.

8. The method of printing an internal bridge in a three-dimensional object of claim 1, further comprising:
(a) depositing a third plurality of drops of the printing material to form an anchor layer adjacent to and in contact with a supported stepout at a third drop spacing;
(b) depositing a plurality of drops of the printing material to form an unsupported stepout adjacent to an in contact with the anchor layer at a second drop spacing; and
(c) repeating steps (b) and (c) until a required number of unsupported stepouts are deposited.

9. The method of printing an internal bridge in a three-dimensional object of claim 1, further comprising increasing a temperature of an area surrounding the three-dimensional object.

10. The method of printing an internal bridge in a three-dimensional object of claim 1, further comprising heating a portion of the internal bridge.

11. The method of printing an internal bridge in a three-dimensional object of claim 1, wherein no print material is deposited between the unsupported stepout or the anchor layer and a substrate.

12. The method of printing an internal bridge in a three-dimensional object of claim 1, wherein no support material is between the unsupported stepout or the anchor layer and a substrate.

13. A printing system for three-dimensional objects, comprising:
a reservoir configured to receive and melt a print material;
an ejector having a nozzle that is fluidly connected to the reservoir to receive melted print material from the reservoir;
a platform positioned opposite the ejector;
at least one actuator operatively connected to at least one of the platform and the ejector, the at least one actuator being configured to move the at least one of the platform and the ejector relative to one another; and
a controller operatively connected to the reservoir, the ejector, and the at least one actuator, the controller being configured to:
deposit a plurality of drops of a printing material in a first direction to form a supported stepout onto an edge of a bridging layer;
deposit a plurality of drops of the printing material to form an anchor layer adjacent to and in contact with the supported stepout; and
deposit a plurality of drops of the printing material to form an unsupported stepout adjacent to an in contact with the supported stepout;
and wherein
the anchor layer is formed with a first drop spacing
the unsupported stepout is formed with a second drop spacing;
the first drop spacing is from about 1.75 times to about 2.50 times that of the second drop spacing; and
an internal bridge formed by the unsupported stepout and the anchor layer are disposed at an angle relative to the edge of the bridging layer of 0 degrees to about 30 degrees.

14. The printing system for three-dimensional objects of claim 13, wherein:
the first drop spacing is 0.7 mm; and
the second drop spacing is 0.32 mm.

15. The printing system for three-dimensional objects of claim 13, wherein each drop of the plurality of drops used to form the unsupported stepout is deposited in the first direction.

16. The printing system for three-dimensional objects of claim 13, wherein each drop of the plurality of drops used to form the anchor layer is deposited in a second direction opposite to the first direction.

17. The printing system for three-dimensional objects of claim 13, wherein the unsupported stepout is formed at a line spacing of 0.25*n mm from a supported stepout, where n is an n'th unsupported stepout.

18. The method of printing an internal bridge in a three-dimensional object of claim 1, wherein the anchor layer is formed at a line spacing of n*0.25+0.125 mm from the supported stepout, where n is an n'th anchor stepout.

19. A method of printing an internal bridge in a three-dimensional object, comprising:
calculating a number of unsupported stepout layers, n, in the internal bridge based on a lateral dimension of an overhang of the internal bridge divided by a line width;
depositing an anchor layer in a first direction at a first drop spacing; and
depositing an unsupported stepout in a second direction at a second drop spacing; wherein:
the second direction is opposite of the first direction.

20. The method of printing an internal bridge in a three-dimensional object of claim 19, wherein the line width is 0.25 mm.

21. The method of printing an internal bridge in a three-dimensional object of claim 19, wherein:
the first drop spacing is 0.7 mm; and
the second drop spacing is 0.32 mm.

22. The method of printing an internal bridge in a three-dimensional object of claim 19, further comprising:
forming the unsupported stepout at a line spacing of 0.25*n mm from a supported stepout, where n is an n'th unsupported stepout; and
forming the anchor layer at a line spacing of n+0.25+0.125 mm from the supported stepout, where n is an n'th anchor stepout.
